(19) United States
(12) Patent Application Publication
(10) Pub. No.: US 2008/0177567 A1
(43) Pub. Date: Jul. 24, 2008

(54) SYSTEM AND METHOD FOR PREDICTIVE MODELING DRIVEN BEHAVIORAL HEALTH CARE MANAGEMENT

(75) Inventors: Mark Friedlander, Narberth, PA (US); Hyong Un, Swarthmore, PA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Aetna Inc., Blue Bell, PA (US)

(21) Appl. No.: 11/625,660

(22) Filed: Jan. 22, 2007

(51) Int. Cl. G06Q 50/00; G06Q 40/00

(52) U.S. Cl. 705/2; 705/4

(57) ABSTRACT

A system and method for administering reductions in future behavioral health care costs through interventions in an insurance plan participant's behavioral health regimen, is disclosed. Information is processed and provided to case managers and/or health care providers in a manner than significantly improves the ability of such individuals to selectively identify plan participants that are most likely to benefit from the intervention. A database is built from a larger set of insurance data, and this data is then further processed to generate, based at least in part on clinical data derived from medical and pharmacy claims, a predictive model that is used to predict the likelihood of future utilization of behavioral health services by a plan participant. The prediction results indicate the relative desirability of intervention in the participant's behavioral health regimen and are used to guide the case, disease, and behavioral health services utilization management for all plan participants.

### RELATED APPLICATIONS

This application is related to U.S. application Ser. No. 10/813,968, filed Mar. 31, 2004, which is hereby incorporated by reference in its entirety.

### FIELD OF THE INVENTION

This invention relates generally to the field of health insurance, and more specifically to health care cost management.

### BACKGROUND OF THE INVENTION

Health insurance plans pay out billions of dollars a year in benefits on behalf of insurance plan participants. Only a small portion of this expenditure, however, is directed to the use of lower cost preventive care to reduce potentially higher cost reactive care. In contrast to reactive health care, preventive health care identifies and reduces the causes of injury and/or illness. A preventive health care regimen, which may include screening for diseases and risk factors, physical examinations, vaccinations, and preventing complications of chronic diseases, may be implemented by health care providers. Health care providers, such as doctors, nurses and their assistants, choose tests, prescribe medicine, make referrals to specialists, counsel and/or use other techniques of proven utility in order to assist the treatment and/or recovery of an individual. Likewise, non-medical case managers can suggest alternatives, such as generic alternatives to name brand drugs, that do not require the advice of a medical professional. Case managers may also provide information to a participant who is unaware of alternative treatments.

As applied to behavioral health care management, the current practice in the managed behavioral health industry involves tightly overseeing all levels of care above routine outpatient treatment. While this may be effective in reducing behavioral health costs driven by facility charges for intensive levels of care, this process has had unintended consequences of increasing provider frustration, member dissatisfaction, and has at times delayed access to needed behavioral health services. The current practice requires allocation of clinical resources to gate-keeping functions that are reactive and do not differentiate between plan members based on variables such as clinical severity, recidivism, treatment compliance, behavioral health pharmacy costs, medical co-morbidity, and likely future utilization patterns, among others.

Despite the well-documented and obvious benefits of preventive medicine, i.e. reducing unnecessary costs and improving the health of the plan participants, insurance companies that have implemented preventive plans have enjoyed only limited success. This was caused, at least in part, by the inability of case managers and health care providers to accurately identify the candidates within an insurance plan who would most benefit from intervention. In addition, prior art approaches failed to make relevant and useful information available to case managers and health care providers in an efficient and user-friendly manner.

Since the late 1960s, the health insurance industry has performed risk assessment on its insured and potential insureds, particularly for individual major medical insurance. Conventional risk assessment involves evaluating blood tests, analyzing attending physician statements, asking a series of medical history questions, and then applying established guidelines that determine whether a person is 25 percent higher cost risk, 50 percent higher cost risk, etc.

Prior art risk assessment methodologies assign risk levels to individuals or a group of enrollees. These risk levels are then used to project the expected costs of subgroups in a population. Existing risk assessment models use two types of data as expected cost predictors: demographic variables and health status. Demographic variables may include age, sex, family status, location, and welfare status, while health status measures can range from self-reported health assessments to requests for diagnoses and prior utilization of medical resources, such as hospitalizations. Models incorporating health status also usually include demographic variables as predictors of costs.

Actuaries have used risk assessment for years in the pricing of health insurance using techniques such as age/sex rating, experience rating, and tier rating. Tier rating is essentially a simplified version of experience rating generally applied to small group populations. Rather than each group having a unique rate based on experience, the experience is used to place that group into one of several “tiers,” the higher-cost tiers reflecting higher historical claims and thus expected costs. HMO premiums for Medicare beneficiaries have also been risk adjusted for more than a decade using variables such as age, sex, geography, welfare and institutional status in a process known as the Adjusted Average Per Capita Cost (“AAPCC”). In more recent years, alternative risk assessment methods have been researched and developed, including models based on health status, as measured by utilization of medical resources and patient diagnoses. The federal government has explored the use of health status measures as alternatives to the AAPCC. Under the umbrella of health care reform, several states have either begun risk adjustment or are in the process of implementing risk adjustment legislation. Risk adjustment refers to the transfer of funds from one plan to another, based upon the risk profile that is observed through risk assessment of all the plans, in an attempt to equalize the playing field among all plans and minimize incentive for avoidance of high-risk enrollees.

Other risk assessment methods include Ambulatory Care Groups (“ACGs”), Diagnostic Cost Groups (“DCGs”), Payment Amounts for Capitated Systems (“PACS”), self-reported health status measures, physiologic health measures, mortality patterns, prior use, the Robinson-Luft Multi-Equation Model the New York State retrospective conditions/procedures payment method, and an elaborate method using marker diagnoses developed in California.

Risk assessment can be performed prospectively or retrospectively, and the risk adjustment process can also be performed prospectively or retrospectively. Generally, prospective risk assessment uses the experience of one year, such as 2001, to predict the risk attributes of an upcoming year, such as 2002. Prospective risk adjustment occurs when funds are transferred from insurers having relatively high risk profiles, as measured through prospective risk assessment, to those having relatively low (prospective) risk profiles. Prospective risk assessment is also applied in setting capitation rates for provider payment purposes. Generally, each insurer builds the expected risk adjustment transfer amounts into their premium rates. A true prospective methodology implies that once the prospective assessments are used to determine transfers, there will be no ultimate transfer of funds based upon actual results. Thus, a true prospective methodology leaves intact a strong incentive to manage medical costs effectively, an incentive that might be removed by retrospective assessment as described below.

Retrospective risk assessment uses the experience of one year to determine the risk assessment attributes of that same year. Likewise, retrospective risk adjustment for a year implies the transfer of payments between carriers based on actual health care costs and risk assessed for that year. A retrospective settlement is an example of retrospective risk adjustment. A reinsurance system for large amount claims is another example of retrospective risk adjustment.

In summary, previous applications of risk assessment and risk adjustment have involved a range of approaches. Efforts by states have typically employed demographic factors such as age, gender, family size and geography, with some method of reinsurance or retrospective adjustment for high cost cases. The application of risk assessment methods in setting capitation payments, profiling providers and performing research on outcomes measurements has typically focused on using age and sex and in some cases, using diagnosis-based approaches such as ACGs and DCGs.

### SUMMARY OF THE INVENTION

Embodiments of the invention are used to provide a system and method for administering reductions in future behavioral health care costs through the efficient use of interventions in an insurance plan participant's behavioral health regimen. Information is processed and provided to insurance organization's case managers and/or health care providers in a manner that significantly improves the ability of such individuals to selectively identify those plan participants who are most likely to benefit from intervention in their behavioral health regimen. A customized database is built or extracted from a larger set of insurance data, and this data is then further processed to generate, based at least in part on behavioral health related clinical data derived from medical and pharmacy claims, a predictive model that is used to predict the likelihood of future utilization of behavioral health services by a plan participant. The prediction results, in turn, indicate the relative desirability of intervention in the participant's behavioral health care regimen and are used to guide the case, disease, and behavioral health services utilization management for all plan participants.

In one embodiment, for each health plan benefit design, member data is extracted based on a member's enrollment in a given plan, availability of behavioral health benefits within the plan, availability of pharmacy benefits, as well as existence of certain behavioral health flags which include the clinical data derived from behavioral health related medical and pharmacy claims. The clinical data includes behavioral health diagnosis data, which is parsed from the member's medical claim information, and pharmacy prescription data derived from pharmacy claim codes. Parameters for the predictive model are determined using the member data extracted from the insurance organization's data warehouse. A predictive model program is comprised of code that executes logic to determine whether certain events may occur. The model is created using known multivariate regression techniques, wherein the subject of the prediction is represented by a dependent variable and other model parameters comprise a set of independent variables. In an embodiment, a dependent variable (predicted risk) is preferably set to identify high risk behavioral health plan members having, within the next 6 months, a 50% or higher likelihood of having a behavioral health related inpatient admission or high monthly behavioral health pharmacy costs. In a preferred embodiment, a predictive model for each health plan benefit design includes independent variables based on behavioral health diagnosis and/or pharmacy data derived from the members' medical and pharmacy claims.

Preferably, behavioral health diagnosis variables are based on flags that include diagnoses related to alcoholism, depression, bipolar disorder, dementia, anxiety, neurosis, psychosis, an eating disorder, a childhood disorder, or substance abuse. Behavioral health diagnosis variables may also include co-morbidity diagnostic flags. Likewise, the pharmacy variables are based on flags that indicate prior use of antianxiety drugs, anticonvulsant drugs, antipsychotic drugs, antidepressant drugs, hypnotic drugs, psychotherapeutic agents, neurological agents, or ADHD drugs.

In one embodiment, a case manager accesses a complete suite of data regarding a suitable intervention candidate via an Internet browser based user interface capable of displaying a prediction status related to the likelihood of future utilization of behavioral health services, as well as other associated data, for each intervention candidate in the predicted data set. The case manager reviews behavioral health information associated with each member's prediction status and assigns the case to a behavioral health care provider for intervention. The health care provider contacts an intervention candidate to screen for intervention eligibility using one or more on-line validated questionnaires and to recommend adjustments to an eligible member's behavioral health care regimen. In an embodiment, the case management user interface is also able to display a list of health plan members which did not fall within the group of members having the likelihood of future utilization of behavioral health services. To this end, the case manager is able to recommend adjusting the health insurance plan benefits of such members to include only a limited number of behavioral health visits when a limitation in behavioral health benefits is allowed by applicable laws. This allows the members outside of the predicted data set to realize cost savings and/or switch to a health insurance plan that covers benefits that are more relevant to the member's overall health status. In yet another embodiment, the insurance organization uses the results of the prediction to determine whether an adjustment to a given member's underwriting status is necessary in light of the presence or absence of the likelihood of future utilization of behavioral health care services.

In one aspect of the invention, a method is provided for administering reductions in future behavioral health care costs for those participants in a health insurance plan for whom the future behavioral health care costs may be reduced through intervention (“intervention candidates”), the method comprising determining a likelihood of future utilization of behavioral health services by an intervention candidate within a predetermined time period, which likelihood is determined based at least in part on a health insurance organization's clinical data, generating a result of the likelihood determination, providing to select individuals access to health care history of the intervention candidate and the result of the likelihood determination, screening the intervention candidate to determine whether the intervention candidate is eligible for intervention, and intervening in a behavioral health care regimen of the intervention candidate when the screening determined that the intervention candidate is eligible for intervention.

In another aspect of the invention, a system is provided for administering reductions in future behavioral health care costs for those participants in a health insurance plan for whom the future behavioral health care costs may be reduced through intervention (“intervention candidates”), the system comprising a computer readable medium having thereon instructions for determining a likelihood of future utilization of behavioral health services by an intervention candidate within a predetermined time period, which likelihood is determined based at least in part on a health insurance organization's clinical data, an on-line questionnaire for screening the intervention candidate to determine whether the intervention candidate is eligible for intervention, wherein the candidate is likely to utilize behavioral health services within the predetermined time period, and a database comprising information related to health care history of the intervention candidate and including a result of at least one of the screening and the likelihood determination.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram of an exemplary environment in which the inventive system and method may be used to input, store, process, sort and display insurance information to case managers and health care providers, as contemplated by an embodiment of the present invention;

FIG. 2 is a flow chart representing the steps associated with selecting and running a predictive model to determine the likelihood of a member's future utilization of behavioral health services, in accordance with an embodiment of the invention;

FIG. 3 is a flow chart representing the steps associated with assigning intervention candidates, identified as a result of the prediction determined in FIG. 2, to health care providers for intervention eligibility screening, in accordance with an embodiment of the invention; and

FIG. 4 is a flow chart representing the steps taken by a health care provider in order to screen the assigned intervention candidate for intervention eligibility and, if appropriate, intervene in the candidate's behavioral health care regimen, in accordance with an embodiment of the invention.

### DETAILED DESCRIPTION OF PREFERRED EMBODIMENTS

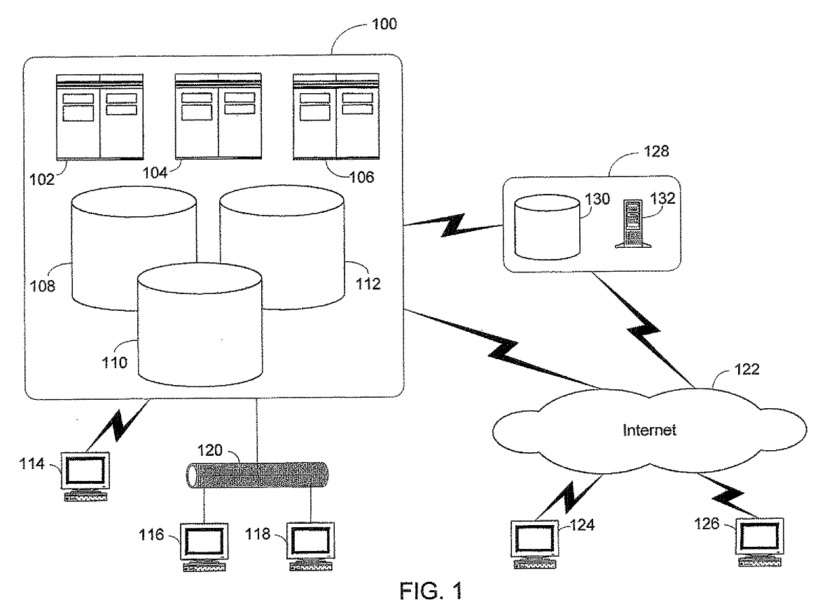

FIG. 1 illustrates a logical arrangement of the environment in which the invention is useful. It will be understood by a person of skill in the art, however, that FIG. 1 is merely exemplary of a computer network environment in which multiple computers interconnect to an insurance system 100. Accordingly, the illustration of FIG. 1 is not meant to limit the number and types of connections to the insurance system 100.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing enviroments, where tasks are performed by remote processing devices that are linked through a communications network. In a distributed computing environment, programs may be located in both local and remote memory storage devices.

Insurance system 100 processes and stores information relating to health insurance plans in a manner known in the art. Such a system includes, for example, data relating to the health care history and claim history of plan participants. The system 100 also processes and stores information that permits proper payment of claims made on behalf of plan participants. As illustrated in the exemplary environment of FIG. 1, insurance system 100 may include multiple interconnected computers 102-106 and databases 108-112. The number and type of computers 102-106 and databases 108-112 are selected to meet the needs of the insurance company that administers insurance plans. Large insurance databases may include several terabytes of data and several data processing computers.

Among other things, the insurance system 100 typically stores information for each plan participant or member. Member data includes, for example, name, member identification number, address, telephone number, age, date of birth, gender, geographic region, member's medical claims, member's pharmacy claims, primary care physician (if appropriate), a last discharge from case management date, a health profile (including diseases or conditions for which the member received treatment and associated dates), and information relating to specialists (including the specialty and date last seen). Preferably, member data also comprises clinical data, which includes behavioral health related diagnosis and pharmacy data contained in a member's medical and pharmacy claims. In embodiments, member data further includes event data, such as inpatient and outpatient procedures and admissions related to behavioral health, as well as financial data, including monetary value associated with each instance of utilization of behavioral health benefits by the member. The insurance system also maintains and stores information relating to each plan. From this data, and using known statistical techniques, the insurance system 100 is able to calculate for each insurance plan participant a likelihood of future utilization of behavioral health services for a predetermined time period, such as for the upcoming 12 months, for example. In one embodiment, the insurance system 100 calculates the likelihood of future utilization of behavioral health services only for such plan participants whose predicted level of utilization of any health services exceeds a predetermined threshold. In such an embodiment, a member's predicted utilization of any health services is known as a “PULSE” score, which is an acronym for Predicted UtiLization by Statistical Evaluation and is calculated in accordance with the applicant's incorporated U.S. application Ser. No. 10/813,968.

Data residing within insurance system 100 may be accessed, and additional data may be input, by directly connected computers, such as computer 114, or by other computers connected via a network, as is schematically illustrated by computers 116, 118 and network 120. Although the exemplary environment of FIG. 1 illustrates only a single computer directly connected to the insurance system and only two computers connected via a network, it will be understood by a person of skill in the art that a large number of computers, whether networked or directly connected to one or more computers within the insurance system 1, will be used to access data within the system or to input new data. The data of insurance system 100 also may be accessed and input via remotely located computers, such as computers 124, 126 and the Internet 122. The illustration of representative computers in FIG. 1 is not intended as a limitation on the number or types of communication with insurance system 100.

Insurance system 100 accepts, stores and acts upon data that is input by administrators and other authorized personnel. For example, information relating to insurance plans offered by the insurance organization and information relating to the individual plan participants must be input to the system. Claims by medical providers and pharmacies also must be input to the system. Likewise, claims by individuals, such as disability claims, are input to the system. The programs and applications running on insurance system 100 use the input data to reconcile premiums, benefits and claims on behalf of plan participants and medical service providers, including behavioral health service providers.

The data processing aspects of the present invention further include an information system 128, which includes a database 130 and computer 132. It will be understood by a person of skill in the art that system 128 may be implemented either as a physically separate structure or as a logically separate structure. In a manner described in more detail below, information system 128 extracts data from the insurance system 100. Computer 132 and the programs running thereon include an Internet server application and an information server that is capable of accessing information on database 130.

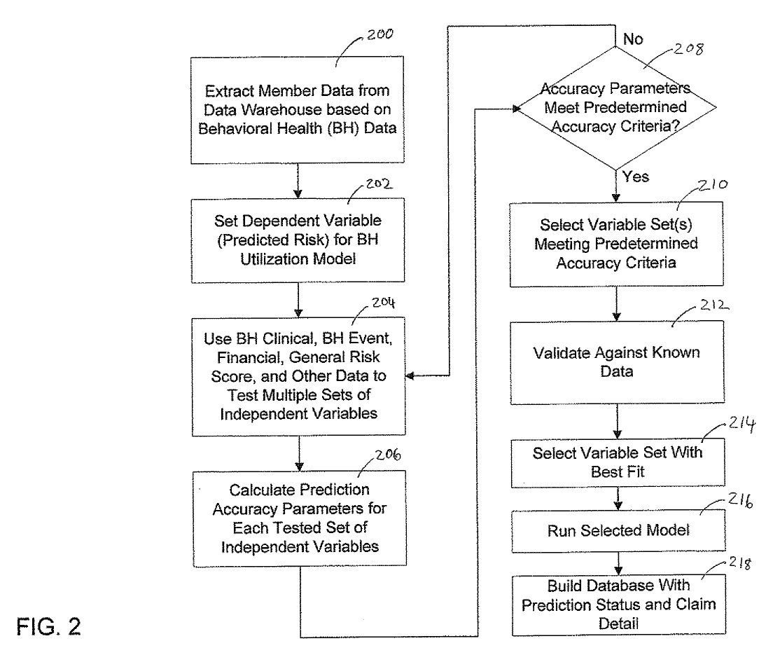

FIG. 2 illustrates an embodiment of the steps associated with selecting and running a predictive model to determine the likelihood of a member's future utilization of behavioral health services in order to administer reductions in future behavioral health care costs for those participants in a health insurance plan for whom such costs may be reduced through intervention in the participant's behavioral health care regimen (“intervention candidates”). This is accomplished via the database and programs running in conjunction with the information system 128 that develop for each intervention candidate a prediction status indicating the result of the likelihood determination. Since the insurance organization offers a plurality of health insurance plans with varying benefit designs, a separate predictive model is preferably created for each health plan benefit design. For example, a separate model is created for PPO, HMO, and POS health plans with and without pharmacy benefits in order to select the model parameters based on claim experience specific to a given benefit design.

Initially, in step 200, the information system 128 extracts member data from the data warehouse of the insurance system 100, which is generally identified in FIG. 1 as databases 108-112. In the illustrated embodiment, for each health plan benefit design, the information system 128 extracts member data based on a member's enrollment in the plan, availability of behavioral health benefits within the plan, availability of pharmacy benefits, as well as existence of certain behavioral health flags. Behavioral health flags include the clinical data derived from behavioral health related medical and pharmacy claims stored in the data warehouse 108-112. Specifically, the clinical data includes behavioral health diagnosis data, which is parsed from the member's medical claim information, and pharmacy prescription data derived from pharmacy claim codes. Preferably, the information system 128 detects the existence of one or more of the behavioral health flags indicated in table one below:

TABLE ONE

| | |
|---|---|
| Behavioral | Alcoholism, Depression, Bipolar Disorder, Dementia, |
| Health | Anxiety, Neurosis, Psychosis, Eating Disorder, Childhood |
| Diagnosis | Disorder, Substance Abuse Related Disorder. |
| Flags | |
| Behavioral | Antidepressant, Antianxiety Agent, Antipsychotic, ADHD, |
| Health | Psychotherapeutic Agent, Neurological Agent, |
| Pharmacy | Anticonvulsant. |
| Flags | |

In an alternative embodiment, the information system 128 uses a threshold amount of behavioral health related medical and/or pharmacy claims as additional criteria for extracting the member data from the data warehouse 108-112.

Next, in step 202-214, parameters for a predictive model program residing within the information system 128 are determined using the member data extracted in step 200. As is known, a predictive model program is comprised of code that executes logic to determine whether certain events may occur. In this case, a predictive model is created to determine the likelihood of a member's future utilization of behavioral health services. The model is created using known multivariate regression techniques, wherein the subject of the prediction is represented by a dependent variable and other model parameters comprise a set of independent variables.

Specifically, in step 202, a dependent variable (predicted risk) is preferably set to identify high risk behavioral health plan members having, within the next 6 months, a 50% or higher likelihood of having a behavioral health related inpatient admission or high monthly behavioral health pharmacy costs. Hence, the model output may be a binary “yes” or “no” prediction of whether or not a given member will satisfy the predicted risk criteria. Alternatively, the model output may be a numerical indicator of probability.

To identify the independent variable set yielding statistically accurate prediction results, an iterative process of steps 204-208 is used. First, in step 204, multiple sets of independent variables are tested to calculate, in step 206, prediction accuracy parameters for each set of independent variables. Prediction accuracy parameters of step 206 may include R-square and Positive Predictive Value (PPV) statistical indicators, for example. Preferably, clinical data is used to identify sets of independent variables for the predictive model. The clinical variables include one or more behavioral health diagnosis flags and one or more behavioral health pharmacy flags identified in Table 1 above. Furthermore, models designed to predict behavioral health benefit utilization for Non-HMO plan benefit designs may include other variables that are based on additional data. For example, such models can include financial, event, as well as member's general risk score variables. The financial variables typically include the value of behavioral health benefits, associated with a particular diagnosis, utilized by the member within a given time period. The event variables include occurrences of certain behavioral health events, such as inpatient hospital admissions. Similarly, general risk score variables are computed using conventional methods for calculating a given member's risk of utilizing any of the benefits under the plan. For each variable set selected in step 204, prediction accuracy parameters are compared 208 to predetermined minimum accuracy thresholds determined using conventional statistical techniques. If the calculated prediction accuracy parameters do not meet or exceed the predetermined values, an alternate set of clinical and other behavioral health variables is selected in step 204. On other hand, when the prediction accuracy parameters for a given variable set meet the predetermined accuracy criteria, the set is selected, in step 210, for validation 212 of the predicted results against known data.

In a preferred embodiment, a predictive model for each health plan benefit design includes variable sets based on behavioral health diagnosis and/or pharmacy data derived from the members' medical and pharmacy claims. Predictive models for health plans where only limited behavioral health diagnosis data is available, such as certain HMO plans with delegated behavioral health services, may rely on independent variable sets comprised entirely of pharmacy related variables. In this case, predictive models comprised of only pharmacy related variables allow members to be identified as high behavioral health risk earlier because delays in medical claim processing will not affect the timing of the model's application. Alternatively, predictive models for health plans that do not include pharmacy benefits may rely on independent variable sets that exclude pharmacy related variables. Tables 2 and 3 below provide examples of variable sets selected in step 214 for having a best fit between the predicted and known actual data.

TABLE TWO
Independent Variables for PPO Plans with Pharmacy Benefits

| Type | Variable |
|---|---|
| Financial | Weighted monthly average behavioral health (BH) |
| | medical claim amount. Greater weight is assigned to the |
| | last 6 months. |
| Financial | Consistency of expenditures related to Eating Disorder for |
| | last 6 months of the validation period. |
| General Risk Score | Weighted quarterly prospective risk score. Greater weight |
| | is assigned to the quarter with the last claims to |
| | emphasize most recent utilization. |
| Event Data | BH Admission Flag - member having a BH related |
| | admission within the validation period. |
| Diagnosis Data | Schizoaffective Disorder Flag - member having an |
| | episode related to this disorder in last 12 months. |
| Diagnosis Data | Substance Abuse Flag - member having an episode |
| | related to Substance Abuse during the validation period. |
| Diagnosis Data (includes co-morbidity) | Depression diagnosis with any other BH diagnosis flags. |
| Diagnosis Data (includes co-morbidity) | Eating Disorder diagnosis with any other BH diagnosis |
| | flags. |
| Pharmacy Data | Anti-anxiety Drug Flag |
| Pharmacy Data | Anti-Convulsant Drug Flag |
| Pharmacy Data | Anti-Psychotic Drug Flag |
| Pharmacy Data | Antidepressant Drug Flag |
| Pharmacy Data | Hypnotic Drug Flag |

TABLE THREE
Independent Variables for HMO Plans With Pharmacy Benefits

| Type | Variable |
|---|---|
| Pharmacy Data | Cost of Antidepressants over a 6 month period. |
| Pharmacy Data | Cost of Antipsychotics over a 6 month period. |
| Pharmacy Data | Cost of Anticonvulsants over a 6 month period. |
| Pharmacy Data | Cost of Psychotherapeutic and Neurological Agents over |
| | a 6 month period. |
| Pharmacy Data | Cost of ADHD drugs over a 6 month period. |
| Pharmacy Data | Cost of antipsychotics over a 6 month period. |

As seen in Tables 2 and 3, the diagnosis and pharmacy variables are derived from the behavioral health diagnosis and pharmacy flags depicted in Table 1 above. Predictive models that include diagnosis flag variables preferably also include co-morbidity variables representing the effect of other disorders on the prime diagnosis, such as Depression or an Eating Disorder diagnosis combined with any of the other behavioral health diagnosis flags depicted in Table 1. It should be understood by those skilled in the art that independent variable sets shown in Tables 2 and 3 are representative embodiments of predictive model parameters for specific plan benefit designs and different combinations of clinical, financial, event, and other data are possible. For example, independent variables for health plans without the pharmacy benefit may include disease flags in the individual's health profile, medical utilization based on behavioral health and non-behavioral health claims, various demographic variables, such as age, sex, region, funding category, and product, as well as family level weighted variables, including cost and retrospective risk scores. Other embodiments include having predictive models that incorporate external data from providers other than insurance system 100 (e.g., from another health plan or pharmacy benefit management database) to allow behavioral health predictions for members who have medical or pharmacy benefits with another health care provider.

Once the variable sets associated with each predictive model are selected 214, the information system 128 runs 216 the prediction program to calculate a prediction status for each member. Next, in step 218, the information system 128 builds a database comprising a prediction status, claim history, and corresponding behavioral health flag detail associated with each intervention candidate. In one embodiment, in order to reduce the computing resources required to calculate and store the prediction status information for health plans with very large numbers of participants, the likelihood of utilization of behavioral health services is calculated in step 216 only for members whose PULSE score exceeds a predetermined threshold. For example, for health plan member data sets exceeding one million members, the likelihood of future utilization of behavioral health services is computed only for members having a PULSE score corresponding to top 0.01% health service utilization.

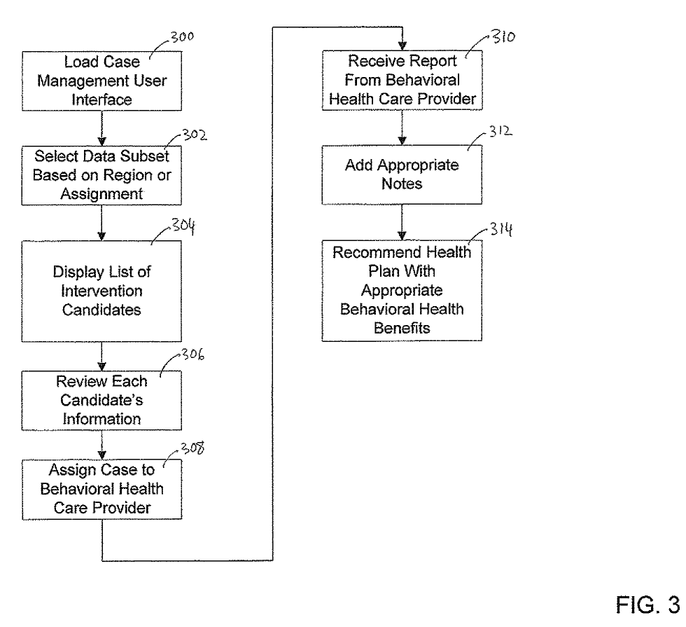

FIG. 3 illustrates an embodiment of the case management process associated with assigning intervention candidates to health care providers for intervention eligibility screening, as well as with intervention in the eligible candidates' behavioral health care regimen. In step 300, following the completion of the prediction status database, the information system 128 loads a case management user interface accessible to case managers within the insurance organization. Preferably, the case management user interface is an on-line interface accessible via a secure Internet browser session using the Internet connection 122 (FIG. 1), and capable of displaying a prediction status related to the likelihood of future utilization of behavioral health services, as well as other associated data, for each intervention candidate in the predicted data set. Typically, in step 302, a case manager uses the case management user interface to select a subset of intervention candidates based on geographic region and/or prior assignment status.

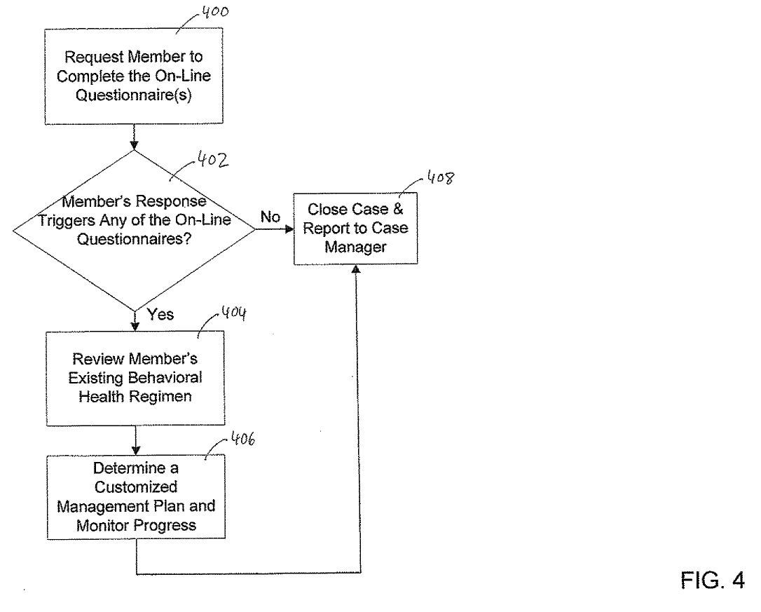

Once a list of intervention candidates is displayed in step 304, the case manager reviews behavioral health information associated with each member's prediction status, step 306, and assigns the case to a behavioral health care provider for intervention, step 308. As discussed in more detail in FIG. 4 below, the health care provider contacts an intervention candidate to screen for intervention eligibility and to recommend adjustments to eligible member's behavioral health care regimen.

Thereafter, in step 310, the health care provider reports the intervention member's behavioral health care status and any progress on the recommended actions to the case manager. Based on the report, the case manager adds the appropriate notes to the member's profile in step 312 and reviews the member's behavioral health benefits to identify whether an adjustment in benefit types or limits is necessary in order to accommodate the member's future behavioral health needs.

Based on such review, the case manager is able to recommend that the member chooses an alternate health insurance plan with behavioral health benefits suited for the member's future utilization requirements, step 314. For example, if a member's health plan does not include a pharmacy benefit, while the health care provider's report indicates that a member's behavioral health care regimen requires anxiety management treatment, the case manager may recommend that the member switch to a health care plan with a pharmacy benefit in order to begin immediate treatment and cover the member's prescription costs. This, in turn, may prevent a future rise in the medical claims related to the member's anxiety diagnosis and allows the health care organization to prevent future increases in behavioral health benefit utilization, while improving the member's behavioral health status.

In an embodiment, the case management user interface is also able to display a list of health plan members which did not fall within the group of members having the likelihood of future utilization of behavioral health services. To this end, the case manager is able to select a list of such members within a given region in order to recommend adjusting the health insurance plan benefits of such members to include only a limited number of behavioral health visits when this limitation in behavioral health benefits is allowed by applicable laws. This allows the members outside of the predicted data set to realize cost savings and/or switch to a health insurance plan that covers benefits that are more relevant to the member's overall health status. In yet another embodiment, the insurance organization uses the results of the prediction to determine whether an adjustment to a given member's underwriting status is necessary in light of the presence or absence of the likelihood of future utilization of behavioral health care services.

FIG. 4 illustrates an embodiment of the steps taken by a health care provider in order to screen the assigned intervention candidate for intervention eligibility and, if appropriate, intervene in the candidate's behavioral health care regimen. First, the health care provider screens the intervention candidate for eligibility via one or more questionnaires designed to indicate whether the candidate is likely to suffer from certain disorders. If the candidate scores below a threshold that indicates one or more potential disorders, the health care provider closes the case and reports the screening results to the case manager. Otherwise, the health care provider intervenes in the member's behavioral health care regimen, monitors progress, and reports same to the case manager for further action.

Specifically, in step 400, the health care provider contacts the intervention candidate to request completion of one or more on-line questionnaires remotely accessible by the intervention candidate via an Internet connection. Preferably, the questionnaires include known previously validated questionnaires used in the behavioral health care field to identify individuals with certain disorders. In one embodiment, the questionnaires include an Alcohol Use Disorders Identification Test (AUDIT), a Patient Health Questionnaire 9 (PHQ9), and a Zung Rating Scale test used to identify alcoholism, depression, and anxiety disorders respectively. Other embodiments include using Self-Rating Depression Scale, Security of Dependence Scale, Addiction Severity Index—Lite (ASI—Lite), or ICD-10 Symptom Checklist For Mental Disorders. In a highly preferred embodiment, an on-line screening interface initially presents an intervention candidate with a short subset of questions from each of the questionnaires and computes a score associated with the candidate's answers to each of the series of prescreening questions. For example, rather than presenting the intervention candidate with all ten questions from an AUDIT alcoholism test, the on-line interface first presents the candidate with three questions from this test. If the candidate's score in response to a given set of prescreening questions is below a minimum threshold, a full questionnaire associated with such prescreening questions is not administered. Otherwise, the candidate is presented with the remaining questions from each of the validated questionnaires that were triggered by the candidate's response. The candidate's score for each of the triggered questionnaires is stored in the database 130 of the information system 128 and is made available to the health care provider.

If the health care provider, in step 402, determines that the candidate's responses to the prescreening questions did not trigger any of the full questionnaires, the health care provider, in step 408, closes the case and reports the result of the eligibility screening to the case manager. On the other hand, when the candidate's responses the one or more fill-length questionnaires indicate that the candidate may suffer from a behavioral health disorder, such as alcoholism, depression, or anxiety, the health care provider, in step 404, reviews the plan participant's current behavioral health regimen. This step includes a review of the participant's demographics and case management history, clinical information pertaining to behavioral health related medical and pharmacy history, the nature of treating specialists, and other similar information. Thereafter, in step 406, the health care provider intervenes by determining a custom case management plan to address the existing behavioral health issues. For example, this plan takes into account the information made readily available through information system 128. The plan includes, as appropriate, referrals to a twenty-four hour counseling line, a mail order pharmacy, Internet web tools/resources, referrals to mental health practitioners, a recommendation to switch prescriptions from a brand name drug to a generic drug, a recommendation that the candidate enter a substance abuse program, and the like. Finally, the health care provider together with the participant establishes short and long term case management goals and monitors progress.

After the case management plan goals are met, the health care provider, in step 408 closes the case and reports the member's current behavioral health status and future recommendations to the case manager. The health care provider also provides the member with a case manager name and telephone number in the event that additional action is required.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for administering reductions in future behavioral health care costs for those participants in a health insurance plan for whom the future behavioral health care costs may be reduced through intervention (“intervention candidates”), the method comprising:
determining a likelihood of future utilization of behavioral health services by an intervention candidate within a predetermined time period, which likelihood is determined based at least in part on a health insurance organization's clinical data;
generating a result of the likelihood determination;
providing to select individuals access to health care history of the intervention candidate and the result of the likelihood determination;
screening the intervention candidate to determine whether the intervention candidate is eligible for intervention; and
intervening in a behavioral health care regimen of the intervention candidate when the screening determined that the intervention candidate is eligible for intervention.

2. The method of claim 1, wherein the step of determining the likelihood of future utilization of behavioral health services further includes determining the likelihood based on at least one of the health insurance organization's financial data, event data, and general risk score data.

3. The method of claim 1, wherein the screening is performed when the result of the likelihood determination indicates a risk that the intervention candidate will incur the costs related to the utilization of behavioral health services within the predetermined time period.

4. The method of claim 3, wherein the risk comprises a likelihood that the intervention candidate will require one of a predetermined amount of pharmacy expenditures related to behavioral health, an inpatient admission related to behavioral health within the predetermined time period.

5. The method of claim 1, wherein the clinical data includes at least one of diagnosis data and pharmacy data.

6. The method of claim 5, wherein the diagnosis data is selected from the group consisting of: alcoholism, depression, bipolar disorder, dementia, anxiety, neurosis, psychosis, an eating disorder, a childhood disorder, and substance abuse.

7. The method of claim 5, wherein the pharmacy data includes one of (1) use of one or more drugs selected from a first group of drugs, and (2) cost of one or more drugs selected from a second group of drugs; and wherein the drugs in the first and second groups of drugs are selected from the group consisting of: an antianxiety drug, an anticonvulsant drug, an antipsychotic drug, an antidepressant drug, a hypnotic drug, a psychotherapeutic agent, a neurological agent, and an ADHD drug.

8. The method of claim 1, wherein the step of intervening includes causing a health care provider to contact the intervention candidate in order to recommend a change in the candidate's behavioral health care regimen.

9. The method of claim 8, wherein the recommendation includes that the candidate switch prescriptions from a brand name drug to a generic drug.

10. The method of claim 8, wherein the recommendation includes that the candidate enter a substance abuse program.

11. The method of claim 8, wherein the recommendation includes that the candidate consult a mental health practitioner.

12. The method of claim 1, wherein the screening to determine whether the intervention candidate is eligible for intervention includes requesting the intervention candidate to complete a validated questionnaire to identify whether the intervention candidate suffers from at least one of alcoholism, depression, and anxiety.

13. The method of claim 12, wherein the questionnaire is an on-line questionnaire.

14. The method of claim 1, wherein the step of intervening includes adjusting at least one of the candidate's underwriting status and benefits under the health insurance plan.

15. The method of claim 1 further including offering to adjust benefits the health insurance plan to include a limited number of behavioral health care provider visits when the result of the likelihood determination indicates that the intervention candidate is not likely to utilize behavioral health services within the predetermined time period.

16. A system for administering reductions in future behavioral health care costs for those participants in a health insurance plan for whom the future behavioral health care costs may be reduced through intervention (“intervention candidates”), the system comprising:
a computer readable medium having thereon instructions for determining a likelihood of future utilization of behavioral health services by an intervention candidate within a predetermined time period, which likelihood is determined based at least in part on a health insurance organization's clinical data;
an on-line questionnaire for screening the intervention candidate to determine whether the intervention candidate is eligible for intervention, wherein the candidate is likely to utilize behavioral health services within the predetermined time period; and
a database comprising information related to health care history of the intervention candidate and including a result of at least one of the screening and the likelihood determination.

17. The system of claim 16 wherein clinical data includes at least one of diagnosis data and pharmacy data.

18. The system of claim 17, wherein the diagnosis data is selected from the group consisting of: alcoholism, depression, bipolar disorder, dementia, anxiety, neurosis, psychosis, an eating disorder, a childhood disorder, and substance abuse.

19. The system of claim 17, wherein the pharmacy data includes one of (1) use of one or more drugs selected from a first group of drugs, and (2) cost of one or more drugs selected from a second group of drugs; and wherein the drugs in the first and second groups of drugs are selected from the group consisting of: an antianxiety drug, an anticonvulsant drug, an antipsychotic drug, an antidepressant drug, a hypnotic drug, a psychotherapeutic agent, a neurological agent, and an ADHD drug.

20. The system of claim 16, wherein the on-line questionnaire is a validated questionnaire used to identify whether the intervention candidate suffers from at least one of alcoholism, depression, and anxiety.
